(19) United States
(12) Patent Application Publication
(10) Pub. No.: US 2018/0290080 A1
(43) Pub. Date: Oct. 11, 2018

(54) DEVICE TO PROVIDE EVEN PRESSURE FOR FILTRATION OF BIOLOGICAL SAMPLE

(71) Applicant: Tokitae LLC, Bellevue, WA (US)

(72) Inventors: Stephen Thomas Graves Burkot, Seattle, WA (US); John Thomas Connelly, Seattle, WA (US); Benjamin David Grant, Bellevue, WA (US); Stephen Paul Harston, Bothell, WA (US); Isaac Santos, Seatac, WA (US); Benjamin K. Wilson, Snoqualmie, WA (US); Ozgur Emek Yildirim, Bellevue, WA (US)

(73) Assignee: Tokitae LLC

(21) Appl. No.: 15/939,756

(22) Filed: Mar. 29, 2018

Related U.S. Application Data
(60) Provisional application No. 62/482,844, filed on Apr. 7, 2017.

(51) Int. Cl. B01D 29/90; G01N 1/40; B01L 3/02; B01L 9/00; B01L 3/00; B01D 29/05; B05C 17/01

(52) U.S. Cl. CPC B01D 29/90; G01N 1/4077; B01L 3/0217; B01L 9/54; B01L 9/50; B01L 3/502; B01D 2201/04; B05C 17/01; G01N 2001/4088; B01L 2200/0631; B01L 2300/0681; B01L 2200/087; B01D 2201/202; B01D 29/05

(57) ABSTRACT

A device for application of even pressure on a plunger head includes: a center rod with a pressure plate affixed at a first end and a back plate positioned adjacent to a second end; a positioning spring adjacent to the pressure plate at a surface distal to the center rod; a positioning plate adjacent to an end of the positioning spring distal to the pressure plate; a housing including an aperture at a position adjacent to a distal surface of the positioning plate; a main spring surrounding the center rod between the back plate and the pressure plate; and a mechanism positioned to move the center rod between the pressure plate and the back plate, the mechanism positioned to compress the main spring between the pressure plate and the back plate in response to force applied by a user.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)).

### PRIORITY APPLICATIONS

The present application claims benefit of priority of U.S. Provisional Patent Application No. 62/482,844, entitled DEVICE TO PROVIDE EVEN PRESSURE FOR FILTRATION OF BIOLOGICAL SAMPLE, naming STEPHEN THOMAS GRAVES BURKOT, JOHN THOMAS CONNELLY, STEPHEN PAUL HARSTON, ISAAC SANTOS, BENJAMIN K. WILSON AND OZGUR EMEK YILDIRIM as inventors, filed 7 Apr. 2017, which was filed within the twelve months preceding the filing date of the present application or is an application of which a currently co-pending priority application is entitled to the benefit of the filing date.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

A device for application of even pressure on a plunger head includes: a center rod with a pressure plate affixed at a first end and a back plate positioned adjacent to a second end; a positioning spring adjacent to the pressure plate at a surface distal to the center rod; a positioning plate adjacent to an end of the positioning spring distal to the pressure plate; a housing including an aperture at a position adjacent to a distal surface of the positioning plate; a main spring surrounding the center rod between the back plate and the pressure plate; and a mechanism positioned to move along the center rod, the mechanism positioned to compress the main spring between the pressure plate and the back plate in response to force applied by a user.

A device for application of even pressure on a plunger head includes: a center rod, the center rod including a pressure plate affixed at a first end; a back plate including an aperture, the center rod traversing the aperture; an end plate including an aperture, the center rod traversing the aperture, the end plate positioned adjacent to the second end of the center rod; two or more support rods positioned alongside the center rod, each support rod connected at a first end to the back plate and at a second end to the end plate; a main spring surrounding the center rod between a position adjacent to the back plate to a position adjacent to the pressure plate; a housing surrounding the center rod, the housing extending around the pressure plate, the housing including an aperture at a position adjacent to a distal surface of the pressure plate; and a mechanism positioned to move to compress the main spring between the pressure plate and the back plate in response to force applied by a user.

A device for application of even pressure on a plunger head and holder thereof includes: a device including; a center rod, the center rod including a pressure plate affixed at a first end, a back plate including an aperture, the center rod passing through the aperture; an end plate including an aperture, the center rod passing through the aperture, the end plate positioned adjacent to the second end of the center rod, two or more support rods positioned alongside the center rod, each support rod connected at a first end to the back plate and at a second end to the end plate, a main spring surrounding the center rod between a position adjacent to the back plate to a position adjacent to the pressure plate, a housing surrounding the center rod, the housing extending around the pressure plate, the housing including an aperture at a position adjacent to a distal surface of the pressure plate, and a mechanism positioned to move to compress the main spring between the pressure plate and the back plate in response to force applied by a user; and a holder for the device including; a base, a housing clamp affixed to the base, the housing clamp of a size shape and position to encircle the housing of the device, a concentrator holder affixed to the base, and a filter unit holder affixed to the base.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a device for application of even pressure.

FIG. 2 is a schematic of a device for application of even pressure on a plunger head.

FIG. 3A is a schematic of a device for application of even pressure.

FIG. 3B is a schematic of a device for application of even pressure.

FIG. 4 is a schematic of a device for application of even pressure on a plunger head.

FIG. 5 is a schematic of a device for application of even pressure.

FIG. 6 is a schematic of a device for application of even pressure.

FIG. 7 is a schematic of a device for application of even pressure.

FIG. 8 is a schematic of a device for application of even pressure.

FIG. 9 is a schematic of a device and holder for application of even pressure on a plunger head.

FIG. 10 is a schematic of a device and holder for application of even pressure on a plunger head.

FIG. 11 is a schematic of a device and holder for application of even pressure on a plunger head.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

For some kinds of biological, medical, and environmental testing, a large volume of fluid is collected that contains a low concentration of an analyte that will be detected in an assay. In order to improve the efficiency, sensitivity and/or specificity of the detection assay in some situations, it is desirable to concentrate the analyte into a pre-processed sample prior to running the detection assay. Similarly, for some kinds of biological, medical, and environmental testing, a volume of fluid is collected that includes extra matter of a larger size than the analyte of interest, for example debris, cellular fragments, molecules, cells, and/or phage. In order for best assay results, it can be desirable to remove some of these larger fluid particles prior to analysis of the sample in an assay. For example some immunoassays, such as lateral flow assays, can be inhibited by such particles and under best practices the particles should be removed in a pre-processing step prior to being added to the assay.

Current methods for pre-processing a liquid sample to concentrate an analyte or removal of larger particles include centrifugation filtration, gravity filtration, and filtration via a syringe pump. These devices generally require a reliable electrical power source to operate, which is not desirable for low resource settings such as disadvantaged regions of the world or emergency situations. In some versions, these other technologies can be limited by volume throughput and the amount of time required to pre-process a fluid sample. Centrifuges and other equipment can also require maintenance that is difficult to obtain in low-resource locations.

In some circumstances, a liquid medical sample (e.g. urine, blood) includes one or more analytes in a diluted form. For example, the mycobacterial lipoarabinomannan (LAM) antigen is a biological marker of clinical interest in tuberculosis (TB) diagnosis and treatment. LAM is present in urine samples from TB-infected individuals, although often present in a low concentration in any given urine sample. LAM can be concentrated from a urine sample prior to analysis to improve concentration, purification, or to remove inhibitors prior to a downstream analysis for the possible presence of LAM for clinical purposes. For example, a urine sample may need to be concentrated to achieve sufficient concentration of LAM in a particular volume to be useful and detectable by immunoassay. Similarly, other analytes and/or markers of medical relevance are present in liquid medical samples.

Concentrators for liquid medical samples can include a device with a plunger positioned to apply force to a liquid sample in order to force the sample through a filter or membrane as part of the concentration process. Depending on the individual user, manual application of the required force to the plunger system may be physically difficult and/or time consuming. Devices that are constructed to provide even pressure of appropriate force to a plunger can be utilized to increase efficiency and reproducibility of this process.

Embodiments of a liquid sample concentrator device and system can be utilized in locations without reliance on available electrical power. Devices and systems can be utilized in low resource settings, for example health clinics in regions without electrical power or with intermittent electrical power availability. Devices and systems can be utilized in low resource settings, for example emergency situations where electrical power is disrupted. Devices and systems are designed for easy use with basic mechanical force from a user's hands and do not require an additional electrical power source. Devices and systems are designed to be easy to use for individuals without extensive training and to have minimal service requirements.

Devices for application of pressure to a liquid medical sample concentrator can be configured as pressure applicators against a system including a plunger. A device includes: a center rod with a pressure plate affixed at a first end and a back plate positioned adjacent to a second end; a positioning spring adjacent to the pressure plate at a surface distal to the center rod; a positioning plate adjacent to an end of the positioning spring distal to the pressure plate; a housing including an aperture at a position adjacent to a distal surface of the positioning plate; a main spring surrounding the center rod between the back plate and the pressure plate; and a mechanism positioned to move the back plate along the center rod, the mechanism positioned to compress the main spring between the pressure plate and the back plate in response to force applied by a user.

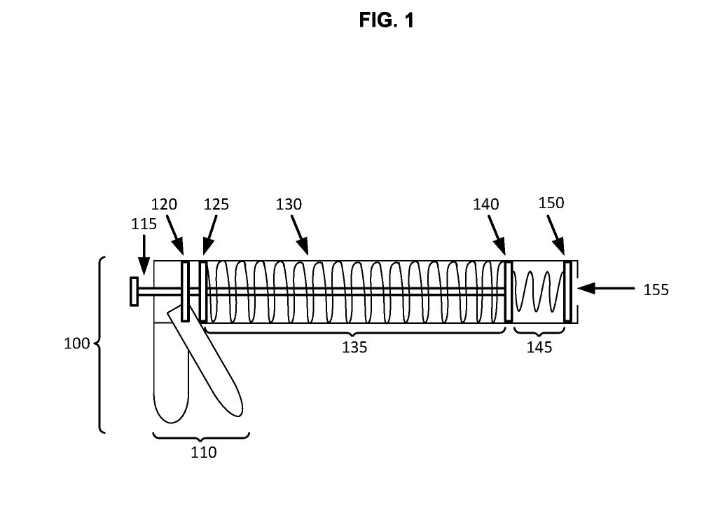

FIG. 1 depicts an embodiment of a device. The device 100 includes a center rod 115, which is centrally positioned within a cylindrical structure formed by the housing 130. A pressure plate 140 is affixed to a first end of the center rod 115. A back plate 125 is positioned adjacent to the second end of the center rod. The back plate 125 includes an aperture, the aperture encircling the center rod 115. The center rod 115 moves back and forth through the aperture in the back plate 125 in response to the mechanism. The back plate 125 is positioned and shaped to move back and forth along the length of the center rod 115 in response to a mechanism. The mechanism is positioned to move the center rod 115 along the long axis of the housing 130, and to compress the main spring 135 between the pressure plate 140 and the back plate 125 in response to force applied by a user. The mechanism depicted in FIG. 1 includes a ratcheting mechanism 120 which is controlled by a user with an attached grip 110. The back plate 125 is positioned adjacent to the ratcheting mechanism 120, with the ratcheting mechanism 120 positioned between the back plate 125 and the second end of the center rod 115. The mechanism can, for example, be similar to that described in U.S. Pat. No. 5,887,765, “Caulk Gun” to Broesamle, which is incorporated by reference herein.

Both the main spring and the positioning spring are compression springs. Both the main spring and the positioning spring are helical springs around a center axis. For the main spring, the center rod is positioned along the center axis. The force of the main spring is higher than the force of the positioning spring. In some embodiments, the force of the main spring is sufficient to put at least 120 psi for at least 3 minutes against a plunger inserted into the device. In some embodiments, the force of the main spring is sufficient to put at least 40 psi against a plunger inserted into the device. Depending on the embodiment, a minimum spring force of the main spring against a plunger inserted into the device lasts for at least 2 minutes, at least 5 minutes, at least 10 minutes, at least 15 minutes, or at least 20 minutes.

At the end of the device 100 distal to the grip 110, the device 100 includes a positioning spring 145 positioned adjacent to the pressure plate 140 at a side of the pressure plate 140 distal to the main spring 135. The positioning spring 145 is located in alignment with the main spring 135, with the center axes of the main spring 135 and the positioning spring 145 in linear alignment. The center rod 115 of the device 100 does not project into the positioning spring 145, but the main axis of the center rod 115 is in linear alignment with the center axis of the positioning spring 145. A positioning plate 150 is adjacent to the end of the positioning spring 145 distal to the pressure plate 140. The positioning spring 145 is located between the pressure plate 140 and the positioning plate 150, with the two respective ends of the spring in contact with the respective plates. The housing 130 includes an aperture 155 adjacent to a side of the positioning plate 150 distal to the positioning spring 145. The aperture 155 is of a size, shape and position to secure a face of an end of a plunger for a medical sample concentration device against the positioning plate 150.

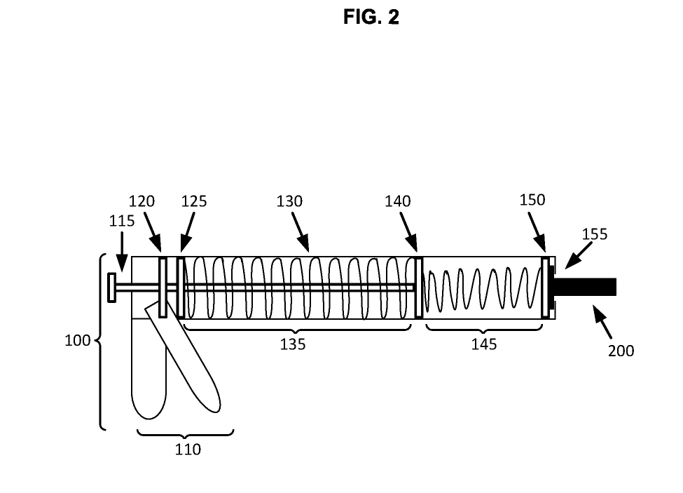

FIG. 2 depicts an embodiment of a device 100 for application of pressure to a liquid medical sample concentrator. The device 100 is similar to the one depicted in FIG. 1. The device 100 includes a center rod 115 with a first end projecting outside of the housing 130 and a second end affixed to the pressure plate 140. A main spring 135 encircles the center rod 115 between the back plate 125 and the pressure plate 140. A mechanism, including a ratchet 120 and a grip 110, controls the position of the center rod 115 relative to the back plate 125. The mechanism, including the ratchet 120 and the grip 110, controls the distance between the back plate 125 and the pressure plate 140. In the view of FIG. 2, the back plate 125 and the pressure plate 140 have been positioned closer to each other than in the view of FIG. 1. This results in compression to the main spring 135. This orientation of the components also permits the positioning spring 145 to extend, spanning the expanded gap between the pressure plate 140 and the positioning plate 150 relative to the view of FIG. 1.

FIG. 2 includes a view of the top of a plunger 200 from a device for concentration of a biological sample. A device for concentration of a biological sample can include, for example, devices described in “Device for Concentration of Biological Sample Prior to Immunoassay,” U.S. application Ser. No. 15/457,009, filed on Mar. 13, 2017, which is incorporated by reference herein. The top of the plunger 200 is of a size and shape to traverse the aperture 155 in the housing 130 adjacent to the positioning plate 150. In the view of FIG. 2, the top of the plunger 200 has a face positioned in contact with a surface of the positioning plate 150 as an adjacent portion of the plunger 200 traverses the aperture 155. Physical pressure from the positioning spring 145 holds the top of the plunger 200 against the surface of the positioning plate 150. When the ratcheting mechanism 120 is released from holding the center rod 115 in a position, the main spring 135 exerts pressure between the back plate 125 and the pressure plate 140. This moves the pressure plate 140 away from the back plate 125, and correspondingly moves the attached center rod 115 along the length of the device 100. Since the main spring 135 has a higher spring force than the positioning spring 145, the positioning spring 145 is compressed and force is transmitted to the positioning plate 150. The force against the positioning plate 150 is in turn transmitted to the adjacent top of the plunger 200.

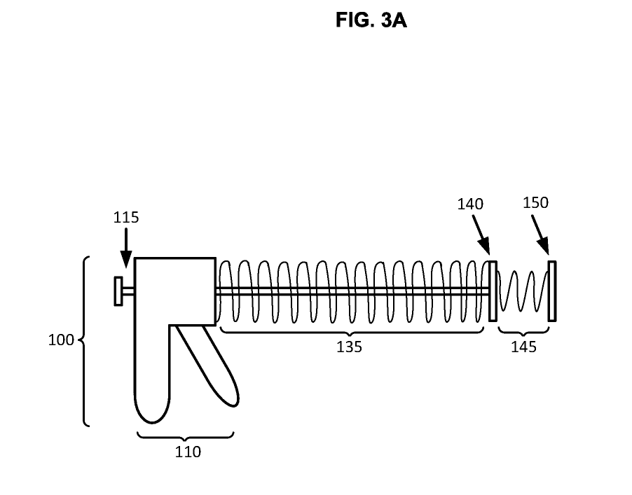

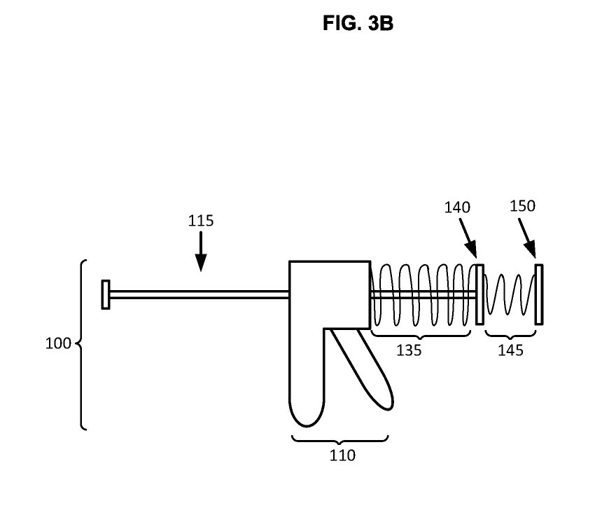

FIG. 3A depicts a partial view of a device with the main spring 135 extended relative to the view of FIG. 3B. This results in a relatively short end of the center rod 115 projecting from the end of the device distal to the pressure plate 140. The positioning spring 145 is also relatively compressed against the positioning plate 150. The position of the components of the device 100 illustrated in FIG. 3A, are, for example, representative of the positioning while the mechanism is released and pressure is being exerted against the end of an attached plunger device.

FIG. 3B depicts a partial view of a device with the main spring 135 compressed relative to the view of FIG. 3A. In this configuration, the end of the center rod 115 projecting from the end of the device distal to the pressure plate 140 is longer than that illustrated in FIG. 3A. The position of the components of the device 100 illustrated in FIG. 3B, are, for example, representative of the positioning while the mechanism is engaged and has ratcheted the center rod 115 through the back plate to shorten the distance between the back plate 125 and the pressure plate 140, thereby compressing the main spring 135.

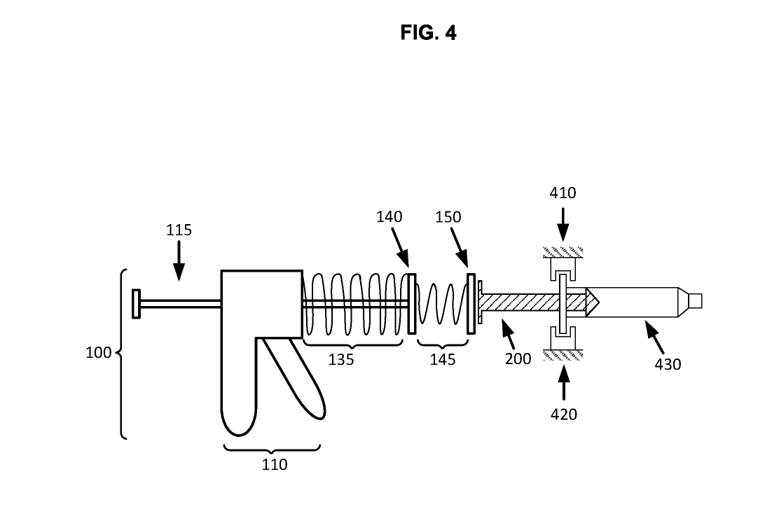

FIG. 4 depicts a device for application of pressure to a liquid medical sample concentrator and a partial view of an attached concentrator. The device 400 includes a mechanism (obscured by the partial cover) a grip 110, a center rod 115, a main spring 135, and a pressure plate 140. A positioning spring 145 is aligned with the main spring 135, the positioning spring 145 with a first end positioned adjacent to a surface of the pressure plate 140 and a second end positioned adjacent to the positioning plate 150. In the illustration, the housing has been partially removed to depict internal components.

A plunger head 200 of a medical sample concentrator device has been positioned adjacent to the side of the positioning plate 150 distal to the contact surface with the positioning spring 145. In some embodiments, part of the housing would surround the end of the plunger head 200 of the medical sample concentrator device to hold it in position during use. The device 400 includes a first clamping structure 410 and a second clamping structure 420 which are of a size, shape and position to hold a part 430 of the medical sample concentrator device securely during use of the device 400. The first clamping structure 410 and the second clamping structure 420 can be, for example, attached to the housing. The first clamping structure 410 and the second clamping structure 420 can be, for example, attached to the positioning plate 150 and configured to securely maintain a predetermined distance between the plunger 200 and part 430 of the medical sample concentrator device during use of the device 400.

A device for application of even pressure on a plunger head includes: a center rod, the center rod including a pressure plate affixed at a first end; a back plate including an aperture, the center rod traversing the aperture; an end plate including an aperture, the center rod traversing the aperture, the end plate positioned adjacent to the second end of the center rod; two or more support rods positioned alongside the center rod, each support rod connected at a first end to the back plate and at a second end to the end plate; a main spring surrounding the center rod between a position adjacent to the back plate to a position adjacent to the pressure plate; a housing surrounding the center rod, the housing extending around the pressure plate, the housing including an aperture at a position adjacent to a distal surface of the pressure plate; and a mechanism positioned to move to compress the main spring between the pressure plate and the back plate in response to force applied by a user.

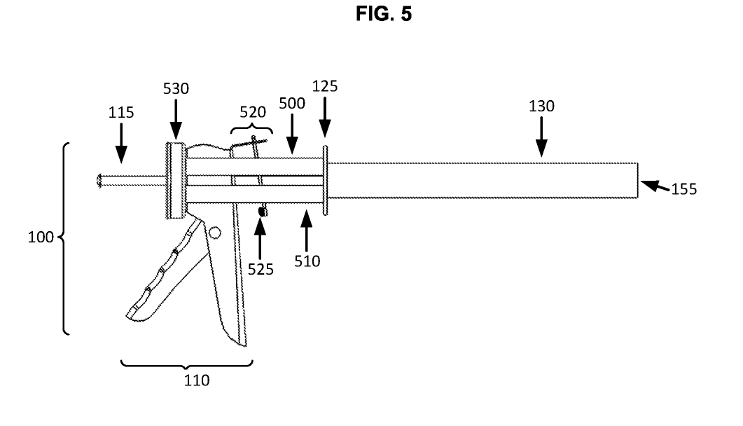

FIG. 5 illustrates aspects of a device for application of even pressure on a plunger head. The device 100 includes a grip 110 of a size, shape and position for an individual user to hold the grip and manipulate it by squeezing the components of the grip. The grip is operably attached to the mechanism positioned to move to compress the main spring between the pressure plate and the back plate in response to force applied by a user. The grip is operably attached to the clamping unit 520 which has a first position to permit motion of the center rod along the axis of the housing, and a second position that puts the clamping unit in contact with the center rod to restrict motion of the center rod. Some embodiments include a magnet 525 positioned on the mechanism so that when the clamping unit 520 of the mechanism is positioned to restrict motion of the center rod 115 along the axis of the housing 130, the magnet assists to secure the clamping unit 520 in position relative to the grip 110.

The device includes a mechanism positioned to move the center rod to compress the main spring between the pressure plate and the back plate in response to force applied by a user. The grip is affixed to the mechanism. The clamping unit is part of the mechanism. In some embodiments, the mechanism positioned to move the center rod is a ratcheting mechanism. For example, the grip can be used to move the center rod and compress the main spring in ratcheted units. In some embodiments, the mechanism positioned to move the center rod is a ratcheting mechanism with a release pressure of at least 40 psi against a plunger positioned adjacent to the positioning plate. In some embodiments, the mechanism positioned to move the center rod is a ratcheting mechanism with a release pressure of at least 120 psi against a plunger positioned adjacent to the positioning plate. In some embodiments, the mechanism includes a magnet positioned to secure the mechanism in a closed position.

The illustrated embodiment includes a center rod 115 which projects along the long axis of the housing 130, in a parallel orientation to the first support rod 500 and the second support rod 510. The center rod 115 passes through an aperture in the end plate 530 at a position adjacent to an end of the center rod 115, to the left in the view of FIG. 5. The center rod 115 passes through an aperture in the back plate 125. The apertures in the back plate and the end plate are of a size, shape and position to permit the center rod to move through the apertures in response to the mechanism. For example in the embodiment illustrated in FIG. 5, the center rod would move to the left and right along the long axis of the center rod in response to the mechanism, and the center rod would change relative positions to the back plate and to the end plate while moving through the apertures in each of the plates. In some embodiments, the plane of the back plate is positioned between 80 and 100 degrees of a main axis of the center rod. In some embodiments, the plane of the end plate is positioned between 80 and 100 degrees of a main axis of the center rod. In some embodiments, the plane of the back plate is positioned perpendicularly to the long axis of the center rod.

There are a plurality of support rods 500, 510 positioned in a parallel orientation to the center rod 115. Some embodiments include a plurality of support rods positioned to surround the center rod. Each support rod has a first end affixed to a surface of the back plate and a second end affixed to a surface of the end plate. In some embodiments, there are 2 support rods. In some embodiments, there are 3 support rods. In some embodiments, there are 4 support rods. In some embodiments there are greater than 4 support rods, for example 5 support rods, 6 support rods, 7 support rods or 8 support rods. The support rods are of a size, shape and position as well as being affixed to the back plate and the end plate securely and sufficiently to maintain the distance between the plates during use. In some embodiments the support rods are of a size, shape and position to minimize the risk of outside objects contacting the center rod or the mechanism including the clamping unit during use to improve safety.

As shown in FIG. 5, a housing 130 is affixed to a surface of the back plate 125 in a position distal to the end plate 530. The housing 130 is affixed to the back plate at a position distal to the mechanism. In some embodiments, the housing defines a cylindrical structure and the center rod is positioned along a center axis along the length of the cylindrical structure. A pressure plate is affixed to the center rod at a position distal to the mechanism. In the view of FIG. 5, the pressure plate is positioned within the housing and not visible in the external viewpoint shown. An aperture 155 of a size and shape to accept a plunger head is positioned at the distal end of the housing 130 (to the right in the view of FIG. 5).

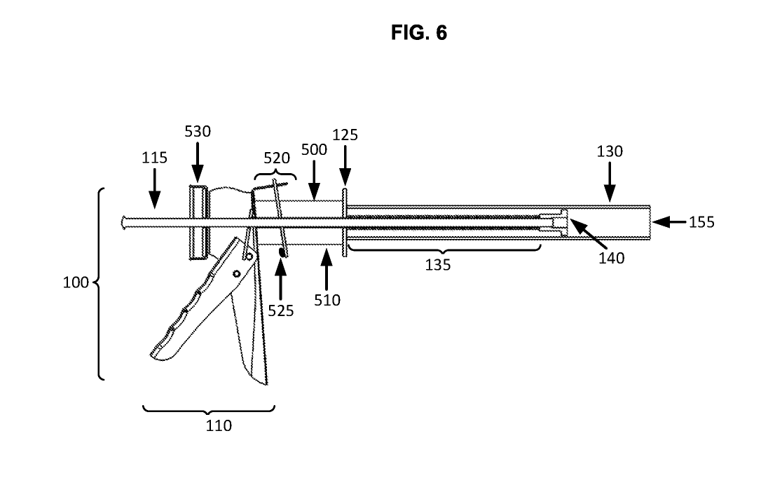

FIG. 6 is a cross-section view of a device for application of even pressure on a plunger head. The view of FIG. 6 is a cross-sectional view along the length of the device to illustrate aspects internal to the device. In this viewpoint, the mechanism has been operated to compress the main spring and move the pressure plate toward the back plate (to the left in the viewpoint of FIG. 6). The device 100 includes a grip 110 attached to a clamping unit 520 which is part of the mechanism positioned to move the center rod 115 to compress the main spring 135 between the pressure plate 140 and the back plate 125 in response to force applied by a user on the grip 110. A magnet 525 is affixed to the clamping unit 520 at a position where it will secure the clamping unit 520 against the adjacent grip 110 surface when the clamping unit 520 is in a position to secure the center rod 115 from movement.

During the action of the mechanism, the center rod 115 moves relative to apertures in the end plate 530 and the back plate 125. This motion is along the long axis of the center rod 115. During the pressure setting action of the mechanism, the center rod 115 is moved to the left in the view of FIG. 6, compressing the main spring 135 between the back plate 125 and the pressure plate 140. Accordingly, the pressure plate 140 is moved away from the aperture 155 at the distal end of the housing 130. A first support rod 500 and a second support rod 510 assist to maintain the position of the back plate 125 relative to the end plate 530 in response to the additional pressure generated on the mechanism of the device 100. As the pressure plate 140 moves away from the aperture 155 in the housing 130 during use, space between the pressure plate 140 and the aperture 155 is made available to insert the end of a plunger of a liquid concentration unit.

The main spring of the device is of a size, shape and composition to transmit the appropriate amount of force along the length of the center rod to the pressure plate. Although the details of the main spring depend on the embodiment and the intended use, the main spring should be of a size, shape and composition to maintain the force along the length of the center rod to the pressure plate during the required filtration time. In some embodiments, the required filtration time is up to 30 minutes. In some embodiments, the required filtration time is up to one hour. In some embodiments, the main spring has an uncompressed length of approximately 28 cm. In some embodiments, the main spring is partially compressed to approximately 20 cm when installed in the device without additional force applied by the mechanism. In some embodiments, the main spring is fully compressed to approximately 14 to 15 cm through the operation of the mechanism on the center rod, and the movement of the center rod to compress the main spring. In some embodiments, the minimum force against the pressure plate from the main spring is approximately 15.75 lbs, and the maximum force is approximately 27.5 lbs.

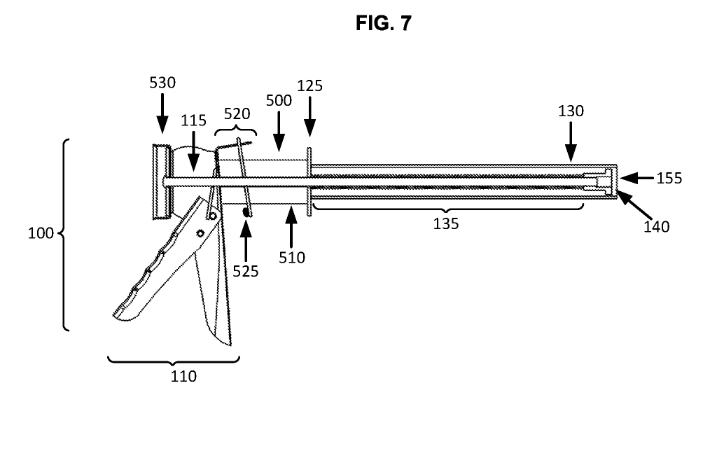

FIG. 7 depicts a cross-section view of a device for application of even pressure on a plunger head. In the view of FIG. 7, the main spring 135 is fully extended and the center rod 115 has correspondingly been moved to the fullest extent possible (right in the view of FIG. 7). In this position, the main spring 135 has extended to the fullest extent possible in the device 100 during routine use. The pressure plate 140 has been moved to a position adjacent to the aperture 155 in the distal end of the housing 130. The end of the center rod 115 is against the aperture in the end plate 530. The end of the center rod 115 positioned against the aperture in the end plate 530; this end of the center rod 115 includes a flange to block the end of the center rod 115 from moving entirely through the aperture.

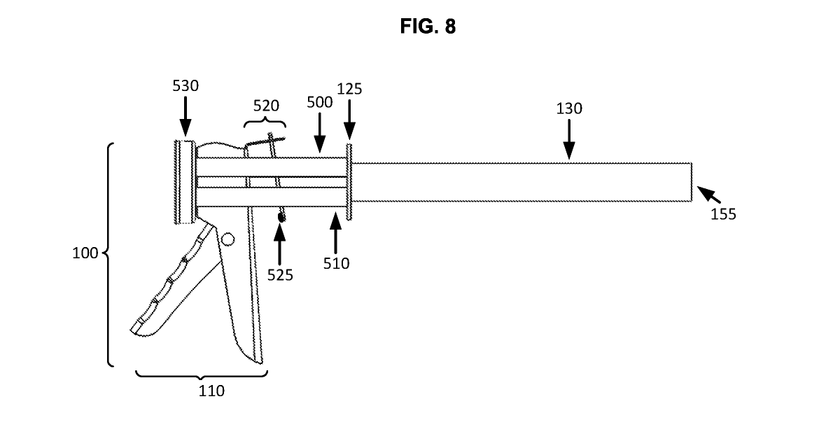

FIG. 8 depicts an external view of the configuration as shown in the cross-section view of FIG. 7. The end of the center rod distal to the pressure plate has been moved against the end plate 530 and is therefore not visible in this view. The pressure plate internal to the housing 130 has been moved to a position adjacent to the aperture 155 in the housing 130.

A device for application of even pressure on a plunger head and a holder thereof includes: a device including; a center rod, the center rod including a pressure plate affixed at a first end, a back plate including an aperture, the center rod passing through the aperture; an end plate including an aperture, the center rod passing through the aperture, the end plate positioned adjacent to the second end of the center rod, two or more support rods positioned alongside the center rod, each support rod connected at a first end to the back plate and at a second end to the end plate, a main spring surrounding the center rod between a position adjacent to the back plate to a position adjacent to the pressure plate, a housing surrounding the center rod, the housing extending around the pressure plate, the housing including an aperture at a position adjacent to a distal surface of the pressure plate, and a mechanism positioned to move to compress the main spring between the pressure plate and the back plate in response to force applied by a user; and a holder for the device including; a base, a housing clamp affixed to the base, the housing clamp of a size shape and position to encircle the housing of the device, a concentrator holder affixed to the base, and a filter unit holder affixed to the base.

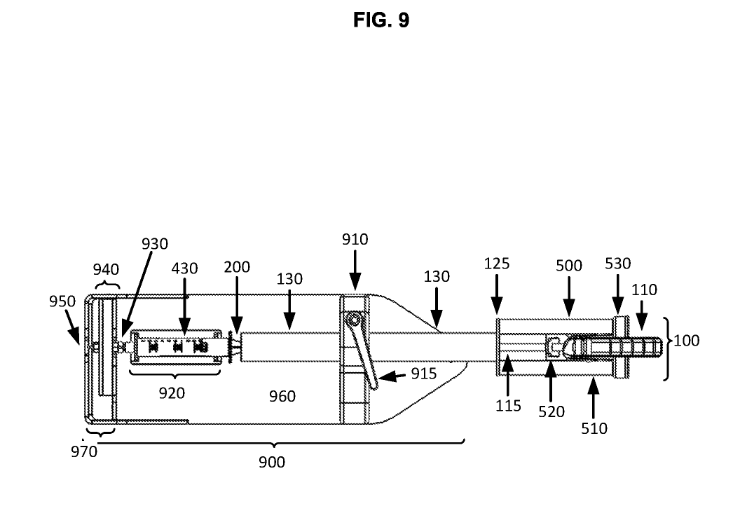

FIG. 9 depicts aspects of a device for application of even pressure on a plunger head and a holder for the device. The device 100 is similar to the ones shown in FIGS. 1 through 8. The device 100 includes a center rod 115, which has an attached pressure plate within the housing 130 surrounding the center rod 115 distal to where the center rod 115 passes through apertures in the back plate 125 and the end plate 530. The device 100 includes two visible support rods 500, 510 affixed at a first end to the back plate 125 and at a second end to the end plate 530, the support rods 500, 510 positioned in parallel with the center rod 115 on either side of the center rod 115 and perpendicular to the back plate 125 and to the end plate 530. Some embodiments include 3 or more support rods positioned radially surrounding the center rod. A grip 110 is attached to a clamping unit 520 of the mechanism positioned to move to compress the main spring between the pressure plate and the back plate 125 along the center rod 115 in response to force applied by a user on the grip 110.

The device 100 is secured by a holder 900 for the device 100. The holder 900 includes a base 960 formed as a substantially planar sheet positioned underneath other components of the base 960. A housing clamp 910 is affixed to the base 960, the housing clamp 910 including a housing clamp release 915. The housing clamp can include a mechanical release. The housing clamp 910 is of a size, shape and position to surround and secure the housing 130 of the device 100 in an appropriate position and orientation for use. The housing clamp 910 includes a mechanism which reversibly secures and releases the housing 130 in response to operation of the housing clamp release 915 by a user.

The holder 900 further includes a concentrator holder 920 affixed to a surface of the base 960. The concentrator holder 920 holds a concentrator part 430, such as a syringe barrel, securely in position for use. In some embodiments, a concentrator holder includes at least one pressure release clamp. In some embodiments, a concentrator holder includes at least two clamps of a size, shape and position to secure a syringe barrel. A plunger 200 is positioned with an end against the pressure plate within the housing 130, in alignment with the center rod 115 to transmit pressure along the length of the center rod 115 to the top of the plunger 200. In some embodiments, the device transmits a release pressure of at least 40 psi against a plunger positioned adjacent to the positioning plate. In some embodiments, the device transmits a release pressure of at least 120 psi against a plunger positioned adjacent to the positioning plate. In some embodiments, the device transmits a release pressure of approximately 120 psi against a plunger positioned adjacent to the positioning plate. The device maintains firm and regular release pressure against the pressure plate throughout the use of the device.

A filter unit holder 970 is affixed to the surface of the base 960. The filter unit holder 970 is of a size, shape and position to align a filter unit 940 to the inlet port 930 and the attached concentrator part 430, such as a syringe barrel, in position for use. The filter unit holder 970 also includes an outlet port 950 aligned to the filter unit 940. In some embodiments, a filter holder includes: a first plate including an inlet port; a second plate including an outlet port; and a gap between the first and the second plates sufficient to position a disposable filter between the plates. In some embodiments, a filter holder includes: a first plate including an inlet port and a concentrate port; a second plate including an outlet port; and a gap between the first and the second plates sufficient to position a disposable filter between the plates.

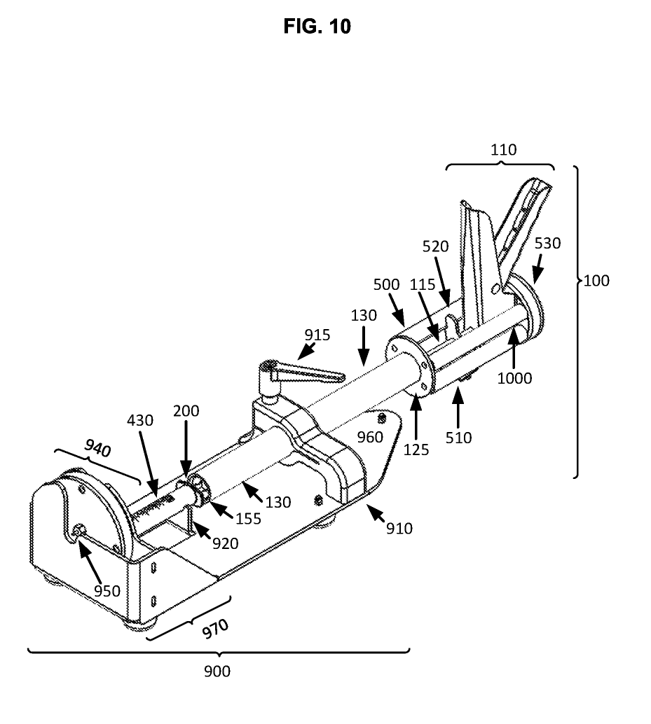

FIG. 10 depicts a device for application of even pressure on a plunger head and a holder for the device. The device 100 includes an end plate 530 and a back plate 125, with three visible support rods 500, 510, 1000 positioned between the end plate 530 and the back plate 125 around the center rod 115. A grip 110 is operably attached to a mechanism including a clamping unit 520 surrounding the center rod 115. Although the grip 110 is inverted from previous views, it is positioned so that a user can grasp and squeeze the grip 110 during use of the device 100. A housing 130 surrounds the center rod 115 distal to the back plate 125.

A holder 900 includes a base 960 with a housing clamp 910, a concentrator holder 920 and a filter unit holder 970 affixed to the top surface of the base 960. A syringe barrel 430 is affixed in the concentrator holder 920, with the top of the plunger 200 traversing the aperture 155 at the end of the housing 130. Within the housing 130 the top of the plunger 200 is positioned in contact with the pressure plate and aligned to move in response to pressure exerted along the center rod 115 through the pressure plate as the main spring extends in response to the mechanism. The syringe barrel 430 affixed in the concentrator holder 920 is similarly aligned to permit the syringe plunger to move within the barrel in response to the force from the device 100.

A filter unit holder 970 holds a filter unit 940 in alignment with the end of the syringe barrel 430 so that liquid from the end of the syringe barrel 430 is forced through the filter unit 940 with the pressure from the device 100. An outlet port 950 on the distal side of the filter unit 940 can be attached to a reservoir as needed, for example a sample retaining reservoir or a waste reservoir, depending on the embodiment.

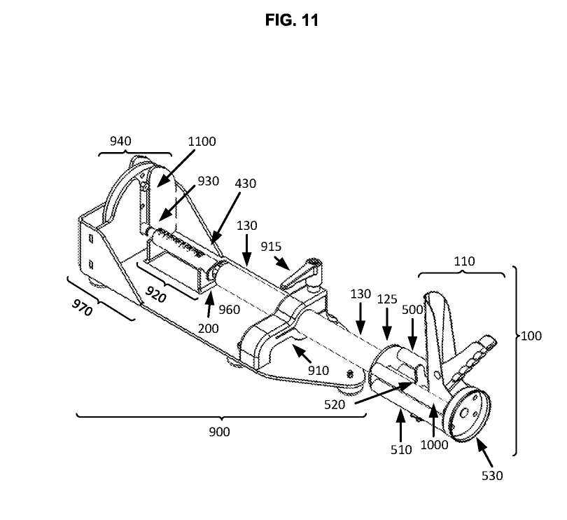

FIG. 11 depicts a device for application of even pressure on a plunger head and a holder for the device. The device 100 is similar to that as described above. The view of FIG. 11 shows the filter unit 940 positioned within the filter unit holder 970. The end of the syringe barrel 430 is positioned to permit fluid flow into the filter unit 940 through the inlet port 930. In the illustrated embodiment, the filter unit 940 also includes a concentrate port 1100 on the same side of the filter unit 940 as the inlet port 930. In some embodiments, for example, the filter unit is used to retain the one or more analytes in a concentrate of the original sample fluid and it is desirable to remove this concentrate from a position adjacent to the inlet port. The filter unit can also include an outlet port on the opposite side, for example for removal of waste liquid from the filter unit.

### EXAMPLE

A device configured for application of even pressure on a plunger head was used to reduce the time needed to filter 10 mL of urine sample for retention of analytes in a filter unit. The device was used to apply 30 lbs of nominal force against the end of a syringe barrel containing the urine sample along the long axis of the syringe barrel. A 2.5 inch diameter Hydrosart filter unit was secured to the end of the syringe distal to the device.

Testing without the device required approximately 20 minutes of manual pressure to filter 10 mL of urine sample. The time required depended on the quality of individual urine samples and ability of an individual to apply pressure to the syringe barrel over time. When the device was utilized, a 10 mL urine sample could be filtered in an average of 4 to 6 minutes with minimal user effort and handling.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A device, comprising:
a center rod, the center rod including a pressure plate affixed at a first end and a back plate positioned adjacent to a second end;
a positioning spring adjacent to the pressure plate at a surface distal to the center rod;
a positioning plate positioned adjacent to an end of the positioning spring distal to the pressure plate;
a housing surrounding the center rod between the back plate and the pressure plate, the housing extending around the positioning plate, the housing including an aperture at a position adjacent to a distal surface of the positioning plate;
a main spring surrounding the center rod between the back plate and the pressure plate; and
a mechanism positioned to move to compress the main spring between the pressure plate and the back plate in response to force applied by a user.

2. The device of claim 1, wherein the housing defines a cylindrical structure and center rod is positioned along a center axis along the length of the cylindrical structure.

3. The device of claim 1, wherein the aperture at a position adjacent to a distal surface of the positioning plate of the housing is of a size and shape to accept a plunger head.

4. The device of claim 1, wherein the mechanism positioned to move the center rod is a ratcheting mechanism.

5. The device of claim 1, wherein the mechanism positioned to move the center rod is a ratcheting mechanism with a release pressure of at least 40 psi against a plunger positioned adjacent to the positioning plate.

6. A device, comprising:
a center rod, the center rod including a pressure plate affixed at a first end;
a back plate including an aperture, the center rod traversing the aperture;
an end plate including an aperture, the center rod traversing the aperture, the end plate positioned adjacent to the second end of the center rod;
two or more support rods positioned alongside the center rod, each support rod connected at a first end to the back plate and at a second end to the end plate;
a main spring surrounding the center rod between a position adjacent to the back plate to a position adjacent to the pressure plate;
a housing surrounding the center rod, the housing extending around the pressure plate, the housing including an aperture at a position adjacent to a distal surface of the pressure plate; and
a mechanism positioned to move the center rod to compress the main spring between the pressure plate and the back plate in response to force applied by a user.

7. The device of claim 6, wherein the pressure plate comprises:
a surface opposite to the length of the center rod, the surface of a size and shape to reversibly mate with a plunger of a concentrator.

8. The device of claim 6, wherein the apertures in the back plate and the end plate are of a size, shape and position to permit the center rod to move through the apertures in response to the mechanism.

9. The device of claim 6, wherein the two or more support rods comprise:
four support rods.

10. The device of claim 6, wherein the two or more support rods are positioned in parallel with the center rod.

11. The device of claim 6, wherein the two or more support rods are positioned surrounding the center rod.

12. The device of claim 6, wherein the plane of the back plate is positioned between 80 and 100 degrees of a main axis of the center rod.

13. The device of claim 6, wherein the plane of the end plate is positioned between 80 and 100 degrees of a main axis of the center rod.

14. The device of claim 6, wherein the housing is affixed to the back plate at a position distal to the mechanism.

15. The device of claim 6, wherein the housing defines a cylindrical structure and the center rod is positioned along a center axis along the length of the cylindrical structure.

16. The device of claim 6, wherein the aperture at a position adjacent to a distal surface of the positioning plate of the housing is of a size and shape to accept a plunger head.

17. The device of claim 6, wherein the mechanism positioned to move the center rod is a ratcheting mechanism.

18. The device of claim 6, wherein the mechanism positioned to move the center rod is a ratcheting mechanism with a release pressure of at least 40 psi against a plunger positioned adjacent to the positioning plate.

19. The device of claim 6, wherein the mechanism positioned to move the center rod is a ratcheting mechanism with a release pressure of at least 120 psi against a plunger positioned adjacent to the positioning plate.

20. The device of claim 6, wherein the mechanism comprises:
a magnet positioned to secure the mechanism in a closed position.

21. A device and holder, comprising:
a device including;
a center rod, the center rod including a pressure plate affixed at a first end,
a back plate including an aperture, the center rod passing through the aperture;
an end plate including an aperture, the center rod passing through the aperture, the end plate positioned adjacent to the second end of the center rod,
two or more support rods positioned alongside the center rod, each support rod connected at a first end to the back plate and at a second end to the end plate,
a main spring surrounding the center rod between a position adjacent to the back plate to a position adjacent to the pressure plate,
a housing surrounding the center rod, the housing extending around the pressure plate, the housing including an aperture at a position adjacent to a distal surface of the pressure plate, and
a mechanism positioned to move to compress the main spring between the pressure plate and the back plate in response to force applied by a user; and
a holder for the device including;
a base,
a housing clamp affixed to the base, the housing clamp of a size shape and position to encircle the housing of the device,
a concentrator holder affixed to the base, and
a filter unit holder affixed to the base.

22. The device of claim 21, wherein the pressure plate comprises:
a surface opposite to the length of the center rod, the surface of a size and shape to reversibly mate with a plunger of a concentrator.

23. The device of claim 21, wherein the apertures in the back plate and the end plate are of a size, shape and position to permit the center rod to move through the apertures in response to the mechanism.

24. The device of claim 21, wherein the two or more support rods comprise:
four support rods.

25. The device of claim 21, wherein the two or more support rods are positioned in parallel with the center rod.

26. The device of claim 21, wherein the two or more support rods are positioned surrounding the center rod.

27. The device of claim 21, wherein the plane of the back plate is positioned between 80 and 100 degrees of a main axis of the center rod.

28. The device of claim 21, wherein the plane of the end plate is positioned between 80 and 100 degrees of a main axis of the center rod.

29. The device of claim 21, wherein the housing is affixed to the back plate at a position distal to the mechanism.

30. The device of claim 21, wherein the housing defines a cylindrical structure and center rod is positioned along a center axis along the length of the cylindrical structure.

31. The device of claim 21, wherein the aperture at a position adjacent to a distal surface of the positioning plate of the housing is of a size and shape to accept a plunger head.

32. The device of claim 21, wherein the mechanism positioned to move the center rod is a ratcheting mechanism.

33. The device of claim 21, wherein the mechanism positioned to move the center rod is a ratcheting mechanism with a release pressure of at least 40 psi against a plunger positioned adjacent to the positioning plate.

34. The device of claim 21, wherein the mechanism positioned to move the center rod is a ratcheting mechanism with a release pressure of at least 120 psi against a plunger positioned adjacent to the positioning plate.

35. The device of claim 21, wherein the mechanism comprises:
a magnet positioned to secure the mechanism in a closed position.

36. The holder of claim 21, wherein the base is positioned underneath the device during use.

37. The holder of claim 21, wherein the housing clamp comprises:
a mechanical release.

38. The holder of claim 21, wherein the concentrator holder comprises:
at least one pressure release clamp.

39. The holder of claim 21, wherein the concentrator holder comprises:
at least two clamps of a size, shape and position to secure a syringe barrel.

40. The holder of claim 21, wherein the filter holder comprises:
a first plate including an inlet port;
a second plate including an outlet port; and
a gap between the first and the second plates sufficient to position a disposable filter between the plates.

41. The holder of claim 21, wherein the filter holder comprises:
a first plate including an inlet port and a concentrate port;
a second plate including an outlet port; and
a gap between the first and the second plates sufficient to position a disposable filter between the plates.
